(19) United States
(12) Patent Application Publication
(10) Pub. No.: US 2024/0223252 A1
(43) Pub. Date: Jul. 4, 2024

(54) PRE-ASSOCIATION SOUNDING IN WIRELESS NETWORKS

(71) Applicant: Cisco Technology, Inc., San Jose, CA (US)

(72) Inventors: Malcolm Smith, Richardson, TX (US); Jerome Henry, Pittsboro, NC (US); Matthew Silverman, Shaker Heights, OH (US); Indermeet Gandhi, San Jose, CA (US)

(21) Appl. No.: 18/607,064

(22) Filed: Mar. 15, 2024

Related U.S. Application Data
(60) Provisional application No. 62/612,354, filed on Dec. 30, 2017.

(51) Int. Cl. H04B 7/06; H04W 8/22; H04W 12/06

(52) U.S. Cl. CPC H04B 7/0617; H04B 7/0626; H04W 8/22; H04W 12/06

(57) ABSTRACT

Devices, systems, methods, and processes for pre-association sounding executed between a user device and a network device are described herein. The user device may announce its pre-association sounding capability to the network device. The network device, also supporting pre-association sounding, may transmit a plurality of sounding frames to the user device. The user device may process the plurality of sounding frames, determine channel state information (CSI), and transmit the CSI to the network device. The plurality of sounding frames and the CSI may be exchanged between the user device and the network device prior to the user device associating with the network device. By the time the user device associates with the network device, the network device may already have the CSI required for beamforming one or more transmissions towards the user device. Thus, latency overheads associated with sounding are reduced by performing pre-emptive sounding while in a pre-association state.

### CROSS-REFERENCE TO RELATED APPLICATION

This application claims the benefit of U.S. Provisional Patent Application No. 63/612,354, filed Dec. 19, 2023, which is incorporated by reference herein in its entirety.

The present disclosure relates to wireless networks. More particularly, the present disclosure relates to pre-emptively performing sounding for a device that is in a pre-association state or about to roam.

### BACKGROUND

Wi-Fi, or wireless fidelity, is of paramount importance in the modem era as a ubiquitous technology that enables wireless connectivity for a wide range of devices. Its significance lies in providing convenient and flexible internet access, allowing seamless communication, data transfer, and online activities. Wi-Fi has become a cornerstone for connectivity in homes, businesses, public spaces, and educational institutions, enhancing productivity and connectivity for individuals and organizations alike.

Over time, the importance of Wi-Fi has evolved in tandem with technological advancements. The increasing demand for faster speeds, greater bandwidth, and improved security has driven the development of more advanced Wi-Fi standards. However, as technology progresses, the demands of Wi-Fi standards and technologies require increasing evolution and innovations in order to provide enhanced performance, increased capacity, and better efficiency.

Specifically, high density enterprise Wi-Fi networks (e.g., Wi-Fi 8 and next-gen Wi-Fi networks) aim to provide uninterrupted coverage and high bandwidth connectivity to mobile users roaming rapidly across multiple access points (APs). However, standard hand-off procedures incur significant latency overheads, leading to potential service interruptions. Key contributors to this latency include authentication protocols, channel scanning, and beamforming training procedures on the new AP. Standard beamforming training involves an iterative sounding process after association to converge on optimal antenna weights. This beamforming latency further reduces performance and may cause temporary disruption in connectivity, which is especially noticeable immediately after roaming.

### SUMMARY OF THE DISCLOSURE

Systems and methods for pre-emptively performing sounding for a device that is in a pre-association state or about to roam in accordance with embodiments of the disclosure are described herein. In some embodiments, a device includes a processor and at least one network interface controller configured to provide access to a network, and a memory communicatively coupled to the processor, wherein the memory includes a pre-association sounding logic that is configured to receive, from a network device, an indication associated with a pre-association sounding capability, transmit a plurality of sounding frames to the network device, receive channel state information from the network device based at least on the plurality of sounding frames, and beamform at least one transmission to the network device based on the channel state information.

In some embodiments, transmission of the plurality of sounding frames is conducted in advance of an association.

In some embodiments, transmission of the plurality of sounding frames is to a user device.

In some embodiments, association is between the device and the user device.

In some embodiments, receiving of the channel state information is conducted in advance of the association.

In some embodiments, the indication associated with the pre-association sounding capability is received in one of a probe request, an authentication request, or an association request.

In some embodiments, the pre-association sounding logic is further configured to receive a probe request from the network device, generate a probe response augmented with the plurality of sounding frames based on the probe request, and transmit the probe response to the network device.

In some embodiments, the pre-association sounding logic is further configured to receive a probe request from the network device, and transmit, to the network device, a probe response followed by the plurality of sounding frames based on the probe request.

In some embodiments, the pre-association sounding logic is further configured to receive an authentication request from the network device, generate an authentication response augmented with the plurality of sounding frames based on the authentication request, and transmit the authentication response to the network device.

In some embodiments, the pre-association sounding logic is further configured to receive an association request from the network device, generate an association response augmented with the plurality of sounding frames based on the association request, and transmit the association response to the network device.

In some embodiments, the pre-association sounding logic is further configured to predict a roaming event for the network device based on telemetry data, and identify one or more target network devices for association with the network device based on the predicted roaming event.

In some embodiments, the pre-association sounding logic is further configured to transmit a sounding schedule of each of the one or more target network devices to the network device.

In some embodiments, the pre-association sounding logic is further configured to receive new channel state information for each of the one or more target network devices from the network device, and transmit the new channel state information to each of the one or more target network devices.

In some embodiments, a device includes a processor and at least one network interface controller configured to provide access to a network, and a memory communicatively coupled to the processor, wherein the memory includes a pre-association sounding logic that is configured to transmit, to a network device, an indication associated with a pre-association sounding capability, receive a plurality of sounding frames from the network device, transmit channel state information to the network device based at least on the plurality of sounding frames, and receive at least one beamformed transmission from the network device based on the channel state information.

In some embodiments, to transmit the channel state information, the pre-association sounding logic is configured to generate an association request augmented with the channel state information, and transmit the association request to the network device.

In some embodiments, the pre-association sounding logic is further configured to receive a sounding schedule of one or more target network devices from the network device associated with the device.

In some embodiments, the pre-association sounding logic is further configured to scan one or more channels based on the sounding schedule.

In some embodiments, the pre-association sounding logic is further configured to receive a plurality of new sounding frames from the one or more target network devices on the one or more channels, and determine new channel state information for each of the one or more target network devices based on the plurality of new sounding frames.

In some embodiments, the device is a Multi-link Device that includes a plurality of transceivers, and is configured to communicate with the network device via one of the plurality of transceivers and concurrently scan the one or more channels via another transceiver of the plurality of transceivers.

In some embodiments, a method for performing sounding includes receiving, from a network device, an indication associated with a pre-association sounding capability, transmitting a plurality of sounding frames to the network device, receiving channel state information from the network device based at least on the plurality of sounding frames, and beamforming at least one transmission to the network device based on the channel state information.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments that a networking logic may operate on a plurality of network devices in accordance with various embodiments of the disclosure;

FIG. 2 is a conceptual diagram illustrating an access point (AP) coordinated pre-association sounding procedure in accordance with various embodiments of the disclosure;

FIG. 3 is a conceptual diagram illustrating an AP coordinated pre-association sounding procedure in accordance with various embodiments of the disclosure;

FIG. 4 is a conceptual diagram illustrating a user device initiated pre-association sounding procedure in accordance with various embodiments of the disclosure;

FIG. 5 is a conceptual diagram illustrating a pre-association sounding procedure in multi-link devices in accordance with various embodiments of the disclosure;

FIG. 6 is a flowchart showing a process for AP coordinated pre-association sounding in accordance with various embodiments of the disclosure;

FIG. 7 is a flowchart showing a process for AP coordinated pre-association sounding in accordance with various embodiments of the disclosure;

FIG. 8 is a flowchart showing a process for user device initiated pre-association sounding in accordance with various embodiments of the disclosure;

FIG. 9 is a flowchart showing a process for user device initiated pre-association sounding in accordance with various embodiments of the disclosure; and

FIG. 10 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that perform sounding in advance of association or concurrently with association. Generally, to join a wireless network or during hand-off, a device (e.g., a user device) is required to perform various operations. For example, the user device may perform a channel scanning process for device discovery, an authentication process to check compatibility, an association process to establish a connection between the user device and a network device (e.g., an access point), and a sounding process to converge on optimal antenna weights for beamformed communication. Standard hand-off procedures incur significant latency overheads, leading to potential service interruptions. Therefore, there is a need for an effective approach to reduce latency overheads and enhance the experience of mobile users. In many embodiments, the user device may perform the sounding process pre-emptively before being associated with the access point (AP). Therefore, the typical latency overhead associated with post-association sounding is reduced by performing pre-association sounding.

In a number of embodiments, the user device may transmit an indication associated with a pre-association sounding capability to the AP. The AP may respond with a plurality of sounding frames based on the indication. The plurality of sounding frames may correspond to null-data packets containing specific signals or sequences, timing information, or the like for sounding purposes. The user device may receive and process the plurality of sounding frames, and determine channel state information (CSI) (e.g., a feedback matrix).

In a variety of embodiments, the user device may transmit the CSI to the AP. The AP may receive the CSI and beamform one or more transmissions to the user device based on the CSI. Beamforming typically refers to a signal processing technique used in wireless networks to focus a transmission in a specific direction. Beamforming technique helps in achieving increased signal strength, higher data rates, and improved coverage. Since the CSI is provided to the AP in advance of association between the user device and the AP, the AP may beamform the one or more transmissions to the user device, for example, even prior to the association or immediately after the association.

In some embodiments, the user device may augment the indication associated with the pre-association sounding capability in a probe request to the AP. In a Wi-Fi network, a probe request is a management frame sent from a network device (e.g., the user device) to discover available networks (e.g., available APs). For example, when a user device wants to actively search for nearby APs to associate with, the user device transmits the probe request. In more embodiments, the user device may augment the indication associated with the pre-association sounding capability in an authentication request or an association request to the AP. In a Wi-Fi network, the authentication request is a management frame sent from a network device (e.g., the user device) to establish its identity to available networks (e.g., available APs). The association request is another management frame that is sent from a network device (e.g., the user device) and may comprise information regarding encryption types, supported data rates, and other 802.11 capabilities of the user device. In additional embodiments, a special message may be defined for the user device to transmit the indication associated with the pre-association sounding capability to the AP.

In further embodiments, the AP may augment the plurality of sounding frames in one of a probe response, an authentication response, or an association response transmitted to the user device. In a Wi-Fi network, a probe response is a management frame, transmitted by a network device (e.g., the AP) as a response to a probe request if the network device matches criteria specified in the probe request. The criteria may include information about an AP, such as SSID, security settings, supported data rates, and other parameters. The authentication response is also a management frame, transmitted by a network device (e.g., the AP) in response to an authentication request based on validating the device type or its 802.11 capabilities to join the network. The association response, another management frame, is transmitted by a network device (e.g., the AP) to a user device and may comprise an association ID assigned by the AP to uniquely identify the user device. In still more embodiments, one of the probe response or the authentication response may be enhanced to indicate to the user device that the probe response or the authentication response is followed by the plurality of sounding frames. For example, the probe response may include a flag, which when set may indicate to the user device that the probe response is followed by the plurality of sounding frames. In another non-limiting example, the authentication response may include a flag, which when set may indicate to the user device that the authentication response is followed by the plurality of sounding frames. The plurality of sounding frames may be transmitted in advance of association to the user device in a special message defined for sounding frame transmission.

In still more embodiments, the AP may orchestrate optimized pre-association sounding between the user device, which is currently served by the AP and is about to roam, and one or more target network devices (e.g., one or more target APs) that can effectively serve the user device after roaming. In a Wi-Fi network, roaming or hand-off refers to a seamless transition of a device (such as a mobile phone, a smartphone, a laptop, or any such computing device) from one network device (such as an AP, Router, or the like) to another network device within the same wireless network or a different wireless network.

In still further embodiments, the AP may predict a roaming event for the user device and identify the one or more target APs with which the user device can re-associate after roaming for uninterrupted service. In still additional embodiments, the AP may execute or implement a Machine Learning model or a predictive logic to predict the roaming event and one or more potential trajectories of the user device. The AP may identify the one or more target APs that can serve the user device if the user device follows any of the one or more potential trajectories.

In some more embodiments, the AP may facilitate an alignment between a scanning schedule of the user device and sounding schedules of the one or more target APs to enable pre-association sounding message exchange between the user device and the one or more target APs. In certain embodiments, the pre-association sounding message exchange between the user device and the one or more target APs may happen via the AP currently serving the user device. In yet more embodiments, the user device may exchange one or more pre-association sounding messages with the one or more target APs independently of the AP currently serving the user device. As such by executing pre-association sounding, latency overheads associated with the iterative sounding procedure are reduced and roaming experience of mobile users is enhanced.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

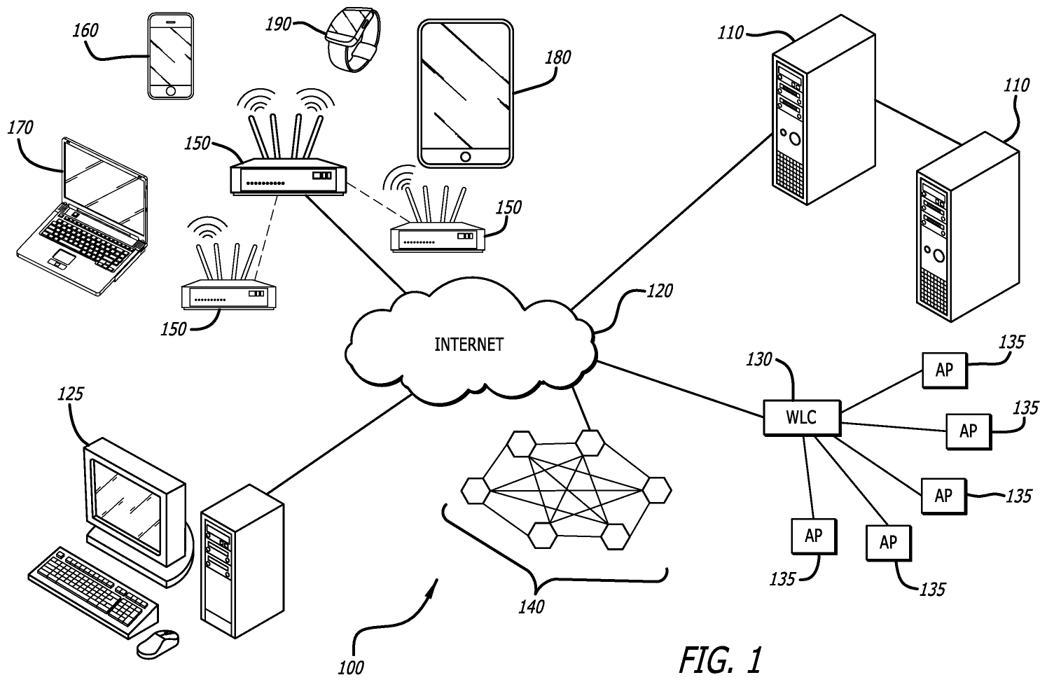

Referring to FIG. 1, a conceptual network diagram 100 of various environments that a networking logic may operate on a plurality of network devices in accordance with various embodiments of the disclosure is shown. Those skilled in the art will recognize that the networking logic can include various hardware and/or software deployments and can be configured in a variety of ways. In many embodiments, the networking logic can be configured as a standalone device, exist as a logic in another network device, be distributed among various network devices operating in tandem, or remotely operated as part of a cloud-based network management tool. In further embodiments, one or more servers 110 can be configured with the networking logic or can otherwise operate as the networking logic. In many embodiments, the networking logic may operate on one or more servers 110 connected to a communication network 120 (shown as the “Internet”). The communication network 120 can include wired networks or wireless networks. The networking logic can be provided as a cloud-based service that can service remote networks, such as, but not limited to a deployed network 140.

However, in additional embodiments, the networking logic may be operated as a distributed logic across multiple network devices. In the embodiment depicted in FIG. 1, a plurality of network access points (APs) 150 can operate as the networking logic in a distributed manner or may have one specific device operate as the networking logic for all of the neighboring or sibling APs 150. The APs 150 may facilitate Wi-Fi connections for various electronic devices, such as but not limited to, mobile computing devices including laptop computers 170, cellular phones 160, portable tablet computers 180 and wearable computing devices 190.

In further embodiments, the networking logic may be integrated within another network device. In the embodiment depicted in FIG. 1, a wireless LAN controller (WLC) 130 may have an integrated networking logic that the WLC 130 can use to monitor or control power consumption of the APs 135 that the WLC 130 is connected to, either wired or wirelessly. In still more embodiments, a personal computer 125 may be utilized to access and/or manage various aspects of the networking logic, either remotely or within the network itself. In the embodiment depicted in FIG. 1, the personal computer 125 communicates over the communication network 120 and can access the networking logic of the servers 110, or the network APs 150, or the WLC 130.

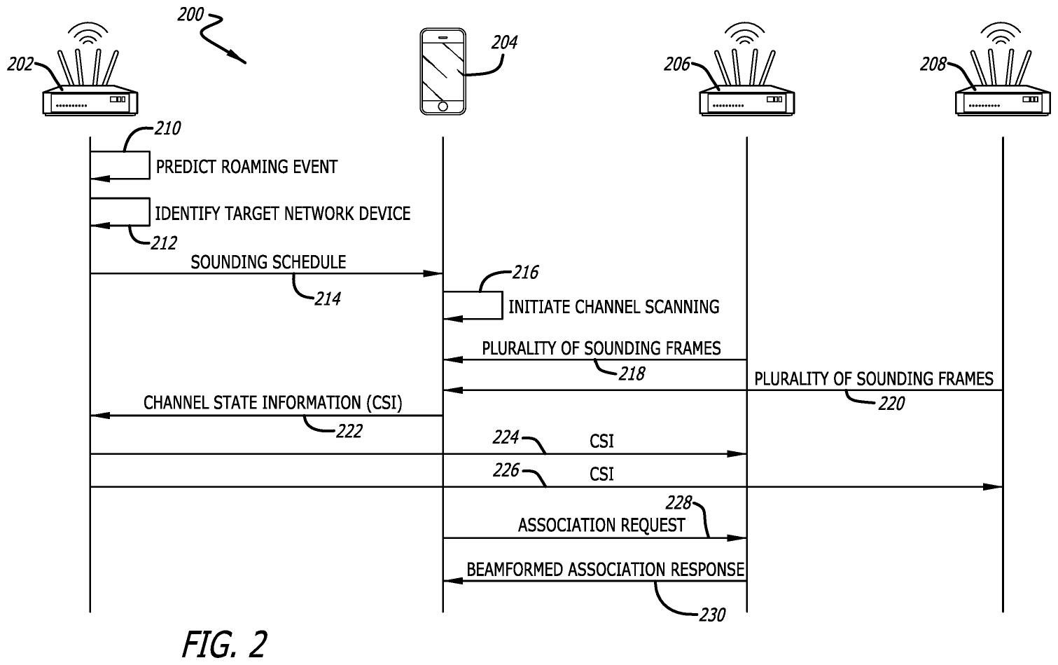

Although a specific embodiment for various environments that the networking logic may operate on a plurality of network devices suitable for carrying out the various steps, processes, methods, and operations described herein is discussed with respect to FIG. 1, any of a variety of systems and/or processes may be utilized in accordance with embodiments of the disclosure. In many non-limiting examples, the networking logic may be provided as a device or software separate from the WLC 130 or the networking logic may be integrated into the WLC 130. The elements depicted in FIG. 1 may also be interchangeable with other elements of FIGS. 2-10 and as required to realize a particularly desired embodiment.

Referring to FIG. 2, a conceptual diagram 200 illustrating an access point (AP) coordinated pre-association sounding procedure in accordance with various embodiments of the disclosure is shown. The embodiments depicted in the conceptual diagram 200 may show a scenario where a network device (e.g., a serving AP 202) is currently associated with another network device (e.g., a user device 204) to provide wireless network access. The embodiments depicted in the conceptual diagram 200 may additionally show a scenario where the serving AP 202 orchestrates a pre-association sounding procedure (e.g., pre-emptive sounding) between the user device 204, which is about to roam, and one or more target network devices (e.g., a first target AP 206 and a second target AP 208). In many embodiments, the serving AP 202 may be aware of a pre-association sounding capability of the user device 204. For example, the AP 202 may receive an indication associated with the pre-association sounding capability from the user device 204. In a number of embodiments, the serving AP 202 may receive the indication prior to associating with the user device 204.

In variety of embodiments, the serving AP 202 may predict a roaming event for the user device 204 (arrow 210). For example, the serving AP 202 may utilize a predictive roaming logic to predict roaming events for various associated user devices. In some embodiments, the predictive roaming logic may be included in the serving AP 202. In more embodiments, the predictive roaming logic can be configured as a standalone device, exist as a logic in another network device, be distributed among various network devices operating in tandem, or remotely operated as part of a cloud-based network management tool. The predictive roaming logic may analyze telemetry data associated with at least one of the user device 204 or other user devices to predict the roaming event. The telemetry data can include information, for example, signal strength, location updates, movement patterns, and/or previous network hand-off events. For example, the predictive roaming logic can predict when the user device 204 is likely to roam based on various factors such as weakening signal strength, movement patterns indicating that the user device 204 is on the move, or the like. In additional embodiments, the predictive roaming logic can utilize a machine learning model to predict the roaming event for the user device 204. For example, the telemetry data of the user device 204 may be provided as input to the machine learning model for roaming event prediction.

In further embodiments, the serving AP 202 may identify one or more target APs (e.g., the first target AP 206 and the second target AP 208) as re-association candidates for the user device 204 (arrow 212). For example, the predictive roaming logic may forecast potential future trajectories of the user device 204 by analyzing historical telemetry data indicating movement patterns of the user device 204, and identify which all APs can serve the user device 204 on the potential future trajectories by analyzing coverage area information of the other APs. The serving AP 202 may coordinate pre-association sounding between the user device 204 and the first target AP 206 and the second target AP 208 to enhance roaming experience of the user device 204.

In still more embodiments, the serving AP 202 may transmit sounding schedules of the first target AP 206 and the second target AP 208 to the user device 204 (arrow 214). For example, the sounding schedule of the first target AP 206 may include sounding timings, sounding frequencies, and/or sounding channels of the first target AP 206. Likewise, the sounding schedule of the second target AP 208 may include sounding timings, sounding frequencies, and/or sounding channels of the second target AP 208. The serving AP 202 can sequentially or synchronously transmit the sounding schedules of the first target AP 206 and the second target AP 208 to the user device 204. In further embodiments, APs capable of executing pre-association sounding may share corresponding sounding schedules along with their identifiers (e.g., MAC addresses) with other APs in the same wireless network to facilitate pre-association sounding. In still further embodiments, the serving AP 202 may request the first target AP 206 and the second target AP 208 to share corresponding sounding schedules based on the prediction of the roaming event and the identification of the first target AP 206 and the second target AP 208 as potential candidates for re-association with the user device 204. Based on the request, the first target AP 206 and the second target AP 208 may provide corresponding sounding schedules to the serving AP 202. In still additional embodiments, the serving AP 202 may transmit information related to a scanning schedule of the user device 204 to the first target AP 206 and the second target AP 208. In other words, the serving AP 202 may facilitate an alignment between the scanning schedule of the user device 204 and the sounding schedules of the first target AP 206 and the second target AP 208 to enable seamless pre-association sounding message exchange.

In some more embodiments, the user device 204 can initiate channel scanning based on the received sounding schedules (arrow 216). In other words, the user device 204 may schedule a scanning of one or more channels as per the sounding schedules. Each of the first target AP 206 and the second target AP 208 may transmit a plurality of sounding frames as per the corresponding sounding schedule. Both the first target AP 206 and the second target AP 208 may associate corresponding identifiers (e.g., MAC address) with the transmitted plurality of sounding frames for identification at a destination device (e.g., the user device 204). The plurality of sounding frames may correspond to null-data packets containing specific signals or sequences, timing information, or the like for sounding purposes.

In certain embodiments, the user device 204 may receive the plurality of sounding frames from each of the first target AP 206 and the second target AP 208 while scanning the one or more channels as per the sounding schedule (arrows 218 and 220). The user device 204 may identify a source of the plurality of sounding frames based on corresponding identifiers. In yet more embodiments, the user device 204 may process the plurality of sounding frames and determine channel state information (CSI) for each of the first target AP 206 and the second target AP 208). CSI may include information about characteristics and conditions of a communication channel. For example, the CSI determined based on the plurality of sounding frames from the first target AP 206 may indicate characteristics and conditions of a channel between the user device 204 and the first target AP 206. In some examples, the CSI may be represented in the form of a feedback matrix.

In still yet more embodiments, the user device 204 may transmit the CSI to the serving AP 202 (arrow 222). For example, the user device 204 may transmit a compressed version of combined CSI associated with the first target AP 206 and the second target AP 208 to the serving AP 202. In many further embodiments, the serving AP 202 may transmit the corresponding CSI to each of the first target AP 206 and the second target AP 208 for caching (arrows 224, 226). For example, the serving AP 202 may decompress the received CSI and transmit corresponding CSI to each of the first target AP 206 and the second target AP 208. This enables the first target AP 206 and the second target AP 208 to be equipped with channel measurements (e.g., CSI and corresponding steering matrix) prior to association with the user device 204. Steering matrix is a representation determined by a beamformer (e.g., an AP) based on the CSI to describe spatial relationship of antenna array elements of the beamformer. Thus, each of the first target AP 206 and the second target AP 208 is capable of executing message exchange for authentication process, association process, or the like with the user device 204 via beamformed transmissions, which further reduces the latency overheads associated with hand-offs or roaming. In other words, the serving AP 202 enables coordinated advanced sounding between the user device 204 and the one or more target APs, and caching the CSI at the one or more target APs to be used for instant beamforming during re-association process.

In many further embodiments, the user device 204 may select one of the one or more target APs (for example, the first target AP 206) for re-association and may transmit an association request (e.g., a re-association request) to the selected first target AP 206 (arrow 228). In many additional embodiments, the first target AP 206 may transmit a beamformed association response (e.g., a beamformed transmission) to the user device 204 (arrow 230). The first target AP 206 may utilize the advance knowledge of the CSI to apply beamforming on transmit beams (e.g., the association response) towards the user device 204. In some examples, the first target AP 206 may apply the beamforming immediately as the user device 204 begins to initiate (re)association with the first target AP 206. For example, the first target AP 206 may apply beamforming to all transmissions made to the user device 204 after receiving the CSI, which may also include transmissions made in advance of the user device 204 associating with the first target AP 206.

Although a specific embodiment for an AP coordinated pre-association sounding procedure suitable for carrying out the various steps, processes, methods, and operations described herein is discussed with respect to FIG. 2, any of a variety of systems and/or processes may be utilized in accordance with embodiments of the disclosure. For example, the first target AP 206 and the second target AP 208 may transmit the plurality of sounding frames synchronously as a coordinated channel sounding process in which various candidate target APs transmit sounding frames at precisely the same time or within a small predefined time window. For example, the first target AP 206 and the second target AP 208 may transmit the plurality of sounding frames to the user device 204 sequentially (such as one after the other) until all candidate target APs have completed their channel sounding. The elements depicted in FIG. 2 may also be interchangeable with other elements of FIGS. 1 and 3-10 as required to realize a particularly desired embodiment.

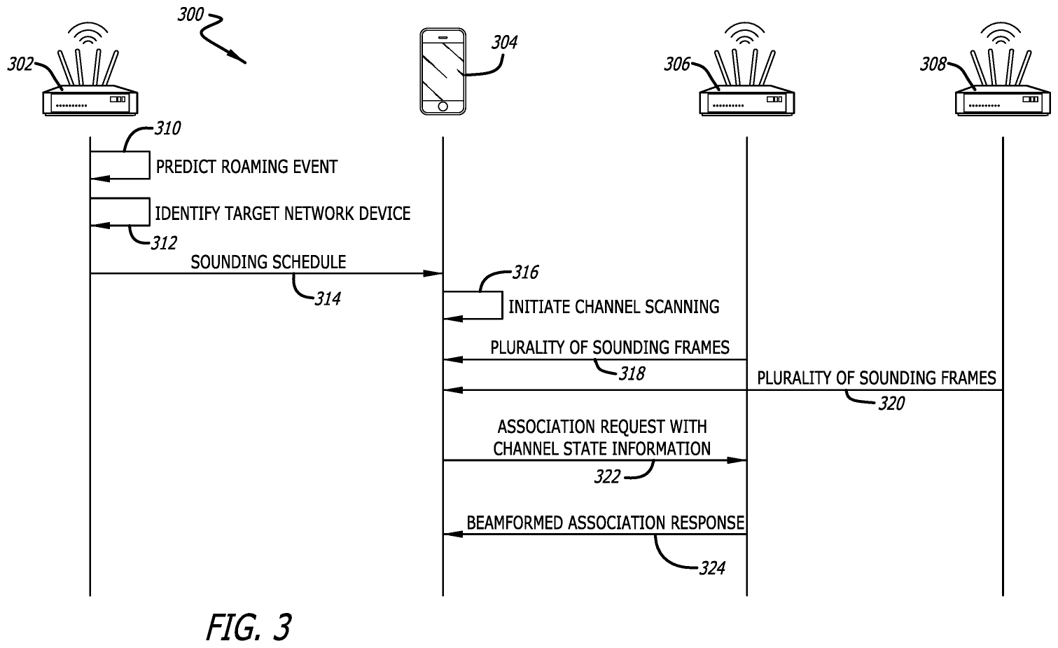

Referring to FIG. 3, a conceptual diagram 300 illustrating an access point (AP) coordinated pre-association sounding procedure in accordance with various embodiments of the disclosure is shown. The embodiments depicted in the conceptual diagram 300 may show a scenario where a network device (e.g., a serving AP 302) is currently associated with another network device (e.g., a user device 304) to provide wireless network access. The embodiments depicted in the conceptual diagram 300 may additionally show a scenario where the serving AP 302 orchestrates a pre-association sounding procedure between the user device 304, which is about to roam, and one or more target network devices (e.g., a first target AP 306 and a second target AP 308). In many embodiments, the serving AP 302 may be aware of a pre-association sounding capability of the user device 304. For example, the serving AP 302 may receive an indication associated with the pre-association sounding capability from the user device 304. In a number of embodiments, the serving AP 302 may receive the indication prior to associating with the user device 304.

In variety of embodiments, the serving AP 302 may predict a roaming event for the user device 304 (arrow 310). For example, the serving AP 302 may utilize a predictive roaming logic to predict roaming events for various associated user devices. The predictive roaming logic may analyze telemetry data associated with at least one of the user device 304 or other user devices to predict the roaming event. For example, the predictive roaming logic can predict when the user device 304 is likely to roam based on various factors such as weakening signal strength, movement patterns indicating that the user device 304 is on the move, or the like. In additional embodiments, the predictive roaming logic can utilize a machine learning model to predict the roaming event for the user device 304.

In further embodiments, the serving AP 302 may identify one or more target APs (e.g., the first target AP 306 and the second target AP 308) as re-association candidates for the user device 304 (arrow 312). For example, the predictive roaming logic may forecast potential future trajectories of the user device 304 by analyzing historical telemetry data indicating movement patterns of the user device 304, and identify which all APs can serve the user device 304 on the potential future trajectories by analyzing coverage area information of other APs.

In still more embodiments, the serving AP 302 may transmit sounding schedules of the first target AP 306 and the second target AP 308 to the user device 304 (arrow 314). In further embodiments, APs capable of executing pre-association sounding may share corresponding sounding schedules along with their identifiers (e.g., MAC addresses) with other APs in the same wireless network to facilitate pre-association sounding. In still further embodiments, the serving AP 302 may request the first target AP 306 and the second target AP 308 to share corresponding sounding schedules based on the prediction of the roaming event and the identification of the first target AP 306 and the second target AP 308 as potential candidates for re-association with the user device 304. Based on the request, the first target AP 306 and the second target AP 308 may provide corresponding sounding schedules to the serving AP 302. In still additional embodiments, the serving AP 302 may transmit information related to a scanning schedule of the user device 304 to the first target AP 306 and the second target AP 308. In other words, the serving AP 302 may facilitate an alignment between the scanning schedule of the user device 304 and the sounding schedules of the first target AP 306 and the second target AP 308.

In some more embodiments, the user device 304 can initiate channel scanning based on the received sounding schedules (arrow 316). Each of the first target AP 306 and the second target AP 308 may transmit a plurality of sounding frames as per the corresponding sounding schedule. Both the first target AP 306 and the second target AP 308 may associate corresponding identifiers (e.g., MAC address) with the transmitted plurality of sounding frames for identification at a destination device (e.g., the user device 304). In certain embodiments, the user device 304 may receive the plurality of sounding frames from each of the first target AP 306 and the second target AP 308 while scanning one or more channels as per the sounding schedule (arrows 318 and 320).

In yet more embodiments, the user device 304 may process the plurality of sounding frames and determine channel state information (CSI) for each of the first target AP 306 and the second target AP 308. In still yet more embodiments, the user device 304 may select one of the one or more target APs (for example, the first target AP 306) for re-association and may transmit an association request (e.g., a re-association request) augmented with corresponding CSI to the selected first target AP 306 (arrow 322). For example, the user device 304 may access various parameters, for example, but not limited to, signal strength, network preference, or security protocols associated with each of the first target AP 306 and the second target AP 308, and select one of the first target AP 306 and the second target AP 308 that meets one or more connectivity requirements. Based on the selection, the user device 304 may generate and transmit the association request augmented with the CSI.

In many additional embodiments, the first target AP 306 may transmit a beamformed association response (e.g., a beamformed transmission) to the user device 304 (arrow 324). For example, the first target AP 306 may receive the association request augmented with CSI. The first target AP 306 may utilize the CSI to determine a steering matrix. The steering matrix may describe spatial relationship of antenna array elements of the first target AP 306. The first target AP 306 may utilize the steering matrix to apply beamforming on a transmit beam (e.g., the association response) towards the user device 304. In other words, the first target AP 306 is capable of applying beamforming on the association response based on an access to the CSI prior to associating with the user device 304.

Although a specific embodiment for an AP coordinated pre-association sounding procedure suitable for carrying out the various steps, processes, methods, and operations described herein is discussed with respect to FIG. 3, any of a variety of systems and/or processes may be utilized in accordance with embodiments of the disclosure. For example, the user device 304 may transmit association requests to a plurality of target APs (e.g., the first target AP 306 and the second target AP 308) and select one of the plurality of target APs for association based on a signal quality of a received beamformed association response. The elements depicted in FIG. 3 may also be interchangeable with other elements of FIGS. 1, 2, and 4-10 as required to realize a particularly desired embodiment.

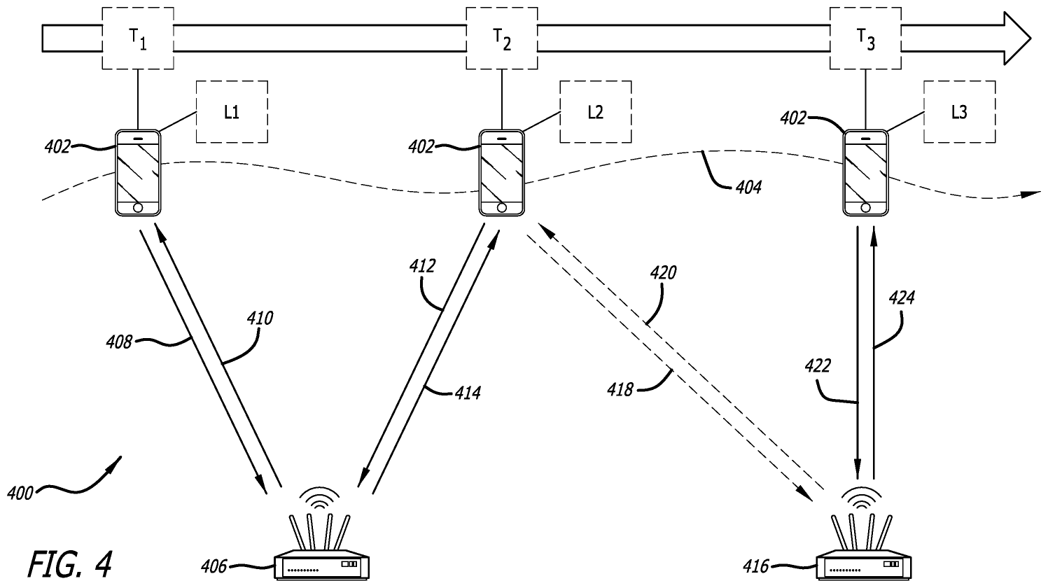

Referring to FIG. 4, a conceptual diagram 400 of a user device initiated pre-association sounding procedure in accordance with various embodiments of the disclosure is shown. The embodiments depicted in the conceptual diagram 400 may show a scenario where a network device (e.g., a user device 402) is moving along a trajectory 404. In many embodiments, the trajectory 404 may refer to a path that the user device 402 follows in a physical space that is served by a Wi-Fi network orchestrated by a plurality of network devices, for example, a first access point (AP) 406 and a second AP 416. In a non-limiting example, the trajectory 404 may correspond to a path that the user device 402 takes while moving from one floor of a building to another floor, the building being served by a Wi-Fi network orchestrated by the first AP 406 and the second AP 416.

In a variety of embodiments, the user device 402, present at a first location L1 at time instance T1, may be associated with the first AP 406. The user device 402 associated with the first AP 406 can exchange data with the first AP 406 through beamformed transmissions 408, 410. In some of the embodiments, as the user device 402 continues to move along the trajectory 404, the user device 402 may reach a second location L2 at a time instance T2. Though at the time instance T2 the user device 402 may be still associated with the first AP 406, the user device 402 may experience weakening or degradation of signal strength or increased time delay in transmissions 412, 414 between the user device 402 and the first AP 406. As a result, the user device 402 may initiate a roaming or a hand-off process to (re)associate with another AP in the Wi-Fi network for uninterrupted network access. For example, the user device 402 may initiate a hand-off process to (re)associate with the second AP 416.

In further embodiments, during the hand-off process, the user device 402 and the second AP 416 may exchange pre-association sounding messages to complete a sounding process in advance of association between the user device 402 and the second AP 416. The pre-association sounding message exchange is depicted through dashed lines 418, 420 in FIG. 4. In still more embodiments, the pre-association sounding message exchange may include transmission of an indication associated with a pre-association sounding capability from the user device 402 to the second AP 416 and transmission of a plurality of sounding frames from the second AP 416 to the user device 402 in response to the indication. In still more embodiments, the pre-association sounding message exchange may include transmission of channel state information (CSI) from the user device 402 to the second AP 416. The CSI may be determined by the user device 402 based on the plurality of sounding frames. In other words, by way of the pre-association sounding message exchange, the CSI may be provided to the second AP 416 in advance of association or concurrently with the association between the user device 402 and the second AP 416.

In still further embodiments, to transmit the indication associated with the pre-association sounding capability to the second AP 416, the user device 402 may augment the indication in one of a probe request, an authentication request, or an association request to the second AP 416. In still additional embodiments, a special message may be defined to transmit the indication associated with the pre-association sounding capability to the second AP 416.

In certain embodiments, to transmit the plurality of sounding frames to the user device 402, the second AP 416 may augment the plurality of sounding frames in one of a probe response, an authentication response, or an association response transmitted to the user device 402. In still additional embodiments, a special message may be defined to transmit the plurality of sounding frames to the user device 402 in advance of association. The special message may be transmitted subsequently to one of the probe response or the authentication response.

In yet more embodiments, to transmit the CSI to the second AP 416, the user device 402 may augment the CSI in an association request to the second AP 416. In still additional embodiments, a special message may be defined to transmit the CSI to the second AP 416 in advance of the association between the user device 402 and the second AP 416.

In still further embodiments, at a time instance T3, the user device 402 may reach a third location L3 on the trajectory 404. By this time, the user device 402 may have successfully disassociated from the first AP 406 and re-associated with the second AP 416. The user device 402 re-associated with the second AP 416 can exchange data with the second AP 416 through beamformed transmissions 422, 424. Based on the reception of the CSI by the second AP 416 in advance of associating with the user device 402, the second AP 416 may beamform one or more transmissions to the user device 402 prior to completion of the association.

Although a specific embodiment for a user device initiated pre-association sounding procedure suitable for carrying out the various steps, processes, methods, and operations described herein is discussed with respect to FIG. 4, any of a variety of systems and/or processes may be utilized in accordance with embodiments of the disclosure. For example, the user device 402 can also perform a pre-association sounding procedure for initial network connection. The elements depicted in FIG. 4 may also be interchangeable with other elements of FIGS. 1-3 and 5-10 as required to realize a particularly desired embodiment.

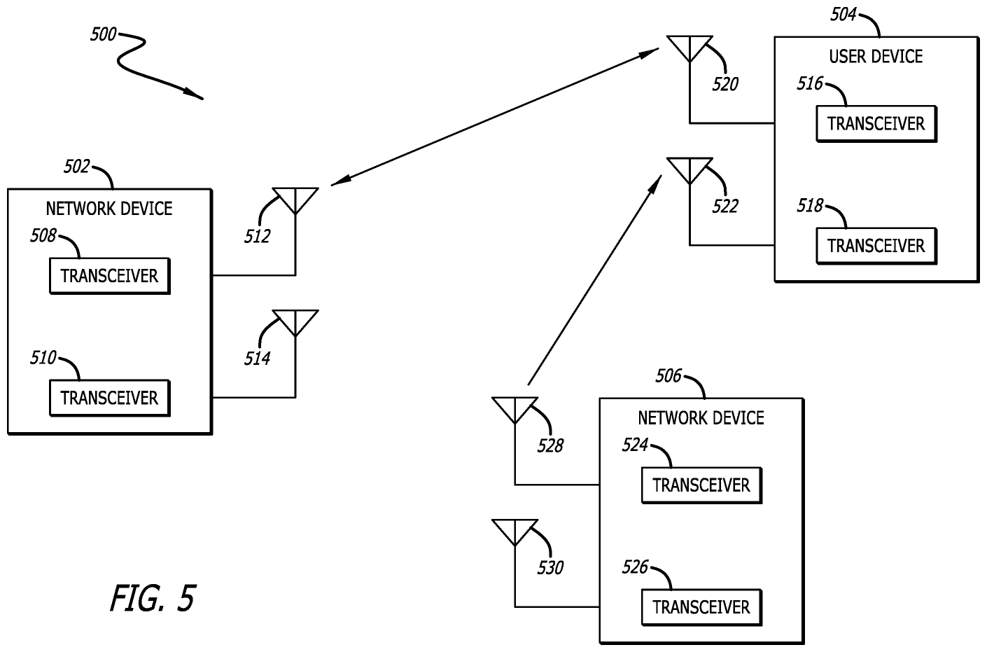

Referring to FIG. 5, a conceptual diagram 500 illustrating a pre-association sounding procedure in multi-link devices in accordance with various embodiments of the disclosure is shown. In many embodiments, a pre-association sounding procedure may be implemented by multi-link devices (MLDs), for example, but not limited to, MLD user devices or MLD access points (APs).

MLD may refer to a device that is capable of simultaneously connecting with multiple network devices (e.g., user devices or APs) within the same network infrastructure. In numerous embodiments, MLD may be a Multi-link Multi Radio (MLMR) device that includes multiple transceivers to send and/or receive data across multiple frequency bands and channels. For example, MLMR device can be connected to a first device via one transceiver and to a second device via another transceiver. In a number of embodiments, the MLD may be an MLMR Non-simultaneous Transmit and Receive (NSTR) device that supports simultaneous transmission/reception on multiple links; however, the MLMR NSTR device may not be capable of transmitting on one link and be receiving on the other link at the same time. In some embodiments, MLD may be Multi-link Single Radio (MLSR) device that has a single transceiver and can support multiple links on the single transceiver. The MLD may change the link only after a fixed static time required for a current transmission to complete. In a variety of embodiments, MLD may operate in an Enhanced Multi-Link Single Radio (eMLSR) mode, which enables an MLD with a single transceiver to switch from one frequency to another frequency dynamically. In eMLSR mode, the MLD may be capable of receiving data on two or more channels; however, can transmit data only on one of the channels.

The embodiments depicted in the conceptual diagram 500 may show a scenario where a first multi-link network device (hereinafter referred to as a first AP 502) is associated with a multi-link user device 504 (hereinafter referred to as the user device 504) to provide network access. The embodiments depicted in the conceptual diagram 500 may additionally show a scenario where the user device 504 performs a pre-association sounding message exchange with a second multi-link network device (hereinafter referred to as a second AP 506) for roaming. In a non-limiting example, the first AP 502, the user device 504, and the second AP 506 are depicted as MLMR devices in FIG. 5. In additional embodiments, any of the first AP 502, the user device 504, and the second AP 506 can operate in MLSR, eMLSR, or MLMR NSTR modes without deviating from the scope of the disclosure.

In further embodiments, the first AP 502 may comprise a first transceiver 508 having a corresponding first antenna 512 and a second transceiver 510 having a corresponding second antenna 514. The user device 504 may comprise a third transceiver 516 having a corresponding third antenna 520 and a fourth transceiver 518 having a corresponding fourth antenna 522. Similarly, the second AP 506 may comprise a fifth transceiver 524 having a corresponding fifth antenna 528 and a sixth transceiver 526 having a corresponding sixth antenna 530.

In further embodiments, the user device 504 may be associated with the first AP 502 and can utilize the third transceiver 516 to communicate with the first AP 502. The user device 504 can concurrently scan one or more channels via the fourth transceiver 518 to receive a plurality of sounding frames from the second AP 506 in advance of association with the second AP 506. For example, the user device 504 can receive the plurality of sounding frames from the second AP 506 via the transceiver 518 during a pre-association sounding procedure.

Although a specific embodiment for an arrangement of multi-linked devices suitable for carrying out the various steps, processes, methods, and operations described herein is discussed with respect to FIG. 5, any of a variety of systems and/or processes may be utilized in accordance with embodiments of the disclosure. For example, the first AP 502 may be MLD mode aware and may use this process to determine an MLD mode of the user device 504 so as to avoid channels not simultaneously receive capable by the user device 504. The elements depicted in FIG. 5 may also be interchangeable with other elements of FIGS. 1-4 and 6-10 as required to realize a particularly desired embodiment.

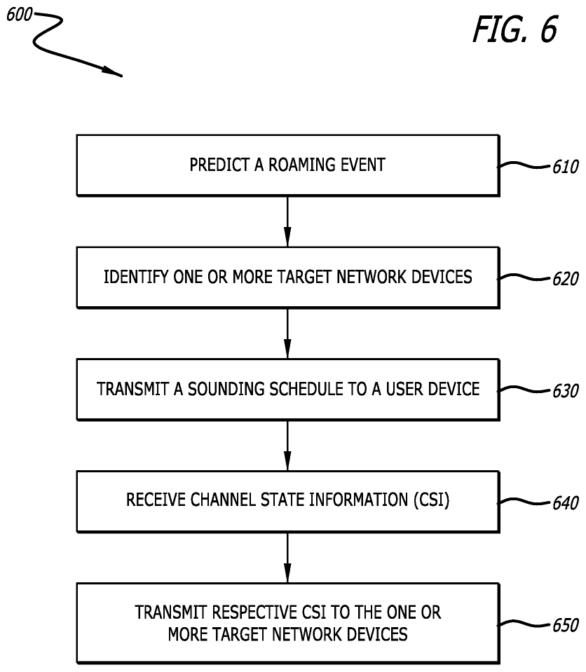

Referring to FIG. 6, a flowchart showing a process 600 for access point (AP) coordinated pre-association sounding in accordance with various embodiments of the disclosure is shown. In many embodiments, the process 600 may predict a roaming event (block 610). In a number of embodiments, the roaming event may be predicted for a user device based on telemetry data associated with the user device. In a variety of embodiments, the telemetry data may include information such as signal strength, location updates, movement patterns, and/or previous network hand-off events of the user device. In more embodiments, the roaming event may be predicted based on a quality of signal strength received from the user device or a movement pattern of the user device. For example, the roaming event may be predicted for the user device based on a weakening signal strength, a movement patterns indicating that the user device is on the move, or the like. In additional embodiments, the roaming event may be predicted when a better signal quality is available to the user device from another AP than a currently serving or associated AP.

In further embodiments, the process 600 may determine one or more target network devices (block 620). The one or more target network devices may be determined as potential roaming candidates. In still more embodiments, the one or more target network devices may be one or more APs that can serve the user device on one or more potential future trajectories of the user device. In still further embodiments, the determination of the one or more target network devices may be based on a machine learning model. In still additional embodiments, the determination of the one or more target network devices may be based on telemetry data of the user device and/or coverage area of various network devices deployed in the wireless network.

In some more embodiments, the process 600 may transmit a sounding schedule (block 630). The sounding schedule may indicate sounding timing, frequency, and/or channels of the one or more target network devices. In certain embodiments, the sounding schedule may be transmitted from a currently associated network device (e.g., a currently serving AP) to the user device for coordinating or aligning a scanning schedule of the user device with the sounding schedules of the one or more target network devices.

In yet more embodiments, the process 600 may receive channel state information (CSI) from the user device (block 640). In still yet more embodiments, the CSI may be determined based on a plurality of sounding frames received by the user device from the one or more target network devices. In many further embodiments, determining the CSI may involve determining a feedback matrix based on the plurality of sounding frames. In many additional embodiments, the CSI may be received, from the user device, for each of the one or more target network devices. In still yet further embodiments, the received CSI can be a compressed version of combined CSI of the one or more target network devices.

In still yet additional embodiments, the process 600 may transmit the CSI to the one or more target network devices (block 650). In several embodiments, transmitting the CSI to the one or more target network devices may include transmitting corresponding CSI to each of the respective one or more target network devices for caching. In several more embodiments, the CSI may be transmitted to the one or more target network devices in advance of association. In numerous embodiments, the CSI may be utilized to beamform a transmission towards the user device.

Although a specific embodiment for an AP coordinated pre-association sounding procedure suitable for carrying out the various steps, processes, methods, and operations described herein is discussed with respect to FIG. 6, any of a variety of systems and/or processes may be utilized in accordance with embodiments of the disclosure. For example, the network device may transmit a scanning schedule of the user device to the one or more target devices to align the sounding schedules of the one or more target network devices with the scanning schedule of the user device. In more examples, the CSI may be transmitted to the one or more target network devices directly by the user device without relaying the CSI through the currently serving network device (e.g., the currently serving AP). The elements depicted in FIG. 6 may also be interchangeable with other elements of FIGS. 1-5 and 7-10 as required to realize a particularly desired embodiment.

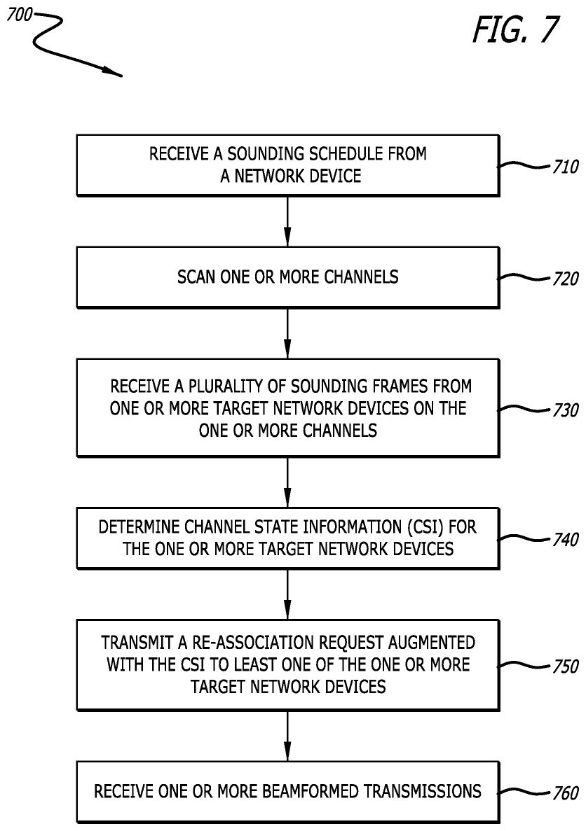

Referring to FIG. 7, a flowchart showing a process 700 for access point (AP) coordinated pre-association sounding in accordance with various embodiments of the disclosure is shown. In many embodiments, the process 700 may receive a sounding schedule from a network device (block 710). In a number of embodiments, the network device may be an access point currently associated with a user device that is capable of pre-association sounding and is about to roam. In a variety of embodiments, the sounding schedule may include information regarding sounding timing, frequency, and channels of one or more target network devices that can serve the user device after hand-off.

In some embodiments, the process 700 may scan one or more channels (block 720). In more embodiments, the one or more channels may be scanned by the user device in accordance with the sounding schedules. In additional embodiments, the scanning of the one or more channels may involve tuning into different radio frequencies indicated in the sounding schedules at preset time points to detect signals from nearby target network devices that support pre-association sounding.

In further embodiments, the process 700 may receive a plurality of sounding frames from the one or more target network devices on the one or more channels (block 730). In still more embodiments, the plurality of sounding frames may be received from the one or more target network devices based on the sounding schedules. A sounding frame may be a null data packet that contains little to no payload data and is utilized for channel measurements or other control purposes rather than carrying actual data. In still further embodiments, the plurality of sounding frames may be received synchronously from the one or more target network devices. In still additional embodiments, the plurality of sounding frames may be received sequentially from the one or more target network devices.

In some more embodiments, the process 700 can determine channel state information (CSI) for the one or more target network devices (block 740). In certain embodiments, the CSI for each of the one or more target network devices may be determined based on corresponding plurality of sounding frames received by the user device. In yet more embodiments, the CSI may be represented as a feedback matrix.

In still yet more embodiments, the process 700 may transmit a re-association request augmented with the CSI to at least one of the one or more target network devices (block 750). In many further embodiments, the user device may transmit the CSI immediately after receiving an association response from a target network device selected from the one or more target network devices. In many additional embodiments, the user device can transmit the association request followed by the CSI. In numerous additional embodiments, the CSI may be transmitted to the target network device in advance of association.

In still additional embodiments, the process 700 may receive one or more beamformed transmissions (block 760). In several embodiments, the user device may receive one or more beamformed transmissions from the target network device in advance of association. In several more embodiments, any transmission received from the target network device after the transmission of the CSI to the target network device may be beamformed based on the CSI.

Although a specific embodiment for an AP coordinated pre-association sounding procedure suitable for carrying out the various steps, processes, methods, and operations described herein is discussed with respect to FIG. 7, any of a variety of systems and/or processes may be utilized in accordance with embodiments of the disclosure. For example, the user device may transmit the CSI to a target network device via a currently serving network device, and the target network device may only utilize the received CSI upon receiving a re-association request from the user device to transmit a beamformed association response. The elements depicted in FIG. 7 may also be interchangeable with other elements of FIGS. 1-6, and 8-10 as required to realize a particularly desired embodiment.

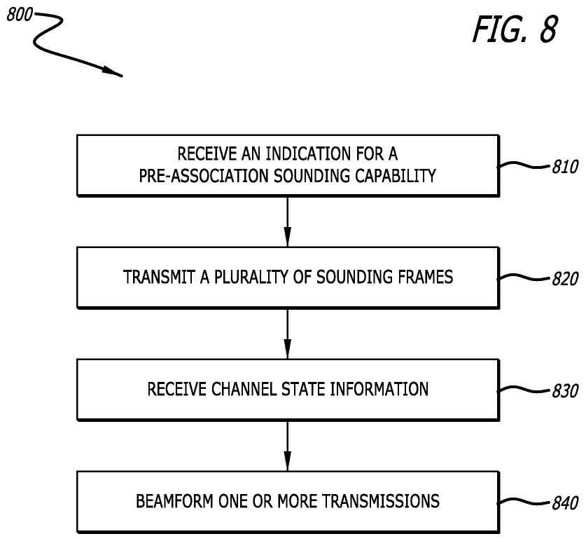

Referring to FIG. 8, a flowchart showing a process 800 for user device initiated pre-association sounding in accordance with various embodiments of the disclosure is shown. In many embodiments, the process 800 may receive an indication for a pre-association sounding capability (block 810). In a number of embodiments, the indication for the pre-association sounding capability can be received by a network device (e.g., an access point, AP) from a user device. In further additional embodiments, the indication for the pre-association sounding capability can be received in a probe request. In a variety of embodiments, the indication for the pre-association sounding capability may be received in an authentication request. In some embodiments, the indication for the pre-association sounding capability can be received in an association request or a re-association request.

In more embodiments, the process 800 may transmit a plurality of sounding frames (block 820). In additional embodiments, the network device may transmit a probe response augmented with the plurality of sounding frames in response to a probe request including the indication for the pre-association sounding capability. In further embodiments, the network device may transmit the probe response followed by the plurality of sounding frames. The probe response may be enhanced to indicate to the user device that the probe response is followed by the plurality of sounding frames. For example, the probe response may include a flag, which when set may indicate to the user device that the probe response is followed by the plurality of sounding frames. In still more embodiments, the network device may transmit the plurality of sounding frames augmented in an authentication response for an authentication request from the user device. In numerous embodiments, the network device may transmit the authentication response followed by the plurality of sounding frames. The authentication response may be enhanced to indicate to the user device that the authentication response is followed by the plurality of sounding frames. For example, the authentication response may include a flag, which when set may indicate to the user device that the authentication response is followed by the plurality of sounding frames. In still further embodiments, the network device may transmit the plurality of sounding frames augmented in an association response for an association request received from the user device. In numerous additional embodiments, the network device may transmit the plurality of sounding frames to the user device in advance of the association with the user device.

In still additional embodiments, the process 800 may receive channel state information (CSI) (block 830). In some more embodiments, the CSI may be received as a part of an association request. In certain embodiments, the CSI may be received after transmitting an association response, augmented with the plurality of sounding frames, to the user device and prior to the completion of the association process. Therefore, as the association between the user device and the network device completes, the network device is ready for transmitting beamformed transmissions or beams to the user device. In yet more embodiments, the CSI can be received in advance of the association. In still yet more embodiments, the CSI may be received concurrently with the completion of association process, for example, immediately as the user devices associates with the network device.

In many further embodiments, the process 800 may beamform one or more transmissions (block 840). In many additional embodiments, the network device may utilize the received CSI to determine a steering matrix and utilize the steering matrix to transmit directional beams towards the user device. In still yet further embodiments, the network device may beamform transmissions to the user device after receiving the CSI from the user device. In still yet additional embodiments, the network device may beamform the one or more transmissions to the user device in advance of association with the user device.

Although a specific embodiment for a user device initiated pre-association sounding procedure suitable for carrying out the various steps, processes, methods, and operations described herein is discussed with respect to FIG. 8, any of a variety of systems and/or processes may be utilized in accordance with embodiments of the disclosure. For example, the network device can be a target AP to which the user device intends to re-associate by leveraging the pre-association sounding capability. The elements depicted in FIG. 8 may also be interchangeable with other elements of FIGS. 1-7, and 9-10 as required to realize a particularly desired embodiment.

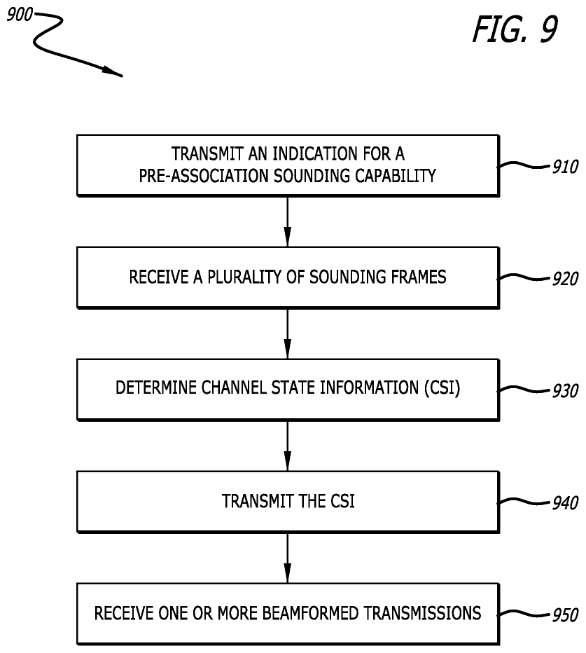

Referring to FIG. 9, a flowchart showing a process 900 for user device initiated pre-association sounding in accordance with various embodiments of the disclosure is shown. In many embodiments, the process 900 may transmit an indication for a pre-association sounding capability (block 910). In a number of embodiments, the indication for the pre-association sounding capability can be transmitted by a user device to a network device (e.g., an access point, AP) that the user device intends to associate with. In additional embodiments, the indication for the pre-association sounding capability can be transmitted in a probe request. In a variety of embodiments, the indication for the pre-association sounding capability may be transmitted in an authentication request. In some embodiments, the indication for the pre-association sounding capability can be transmitted in an association request or a re-association request. In further additional embodiments, the indication for the pre-association sounding capability can be transmitted as a special message defined for indicating the pre-association sounding capability.

In more embodiments, the process 900 may receive a plurality of sounding frames (block 920). In additional embodiments, the user device may receive a probe response augmented with the plurality of sounding frames. In further embodiments, the user device may receive the probe response followed by the plurality of sounding frames. For example, the user device may receive an enhanced probe response that indicates that the probe response is followed by the plurality of sounding frames. In still more embodiments, the user device may receive the plurality of sounding frames augmented in an authentication response. In numerous embodiments, the user device may receive the authentication response followed by the plurality of sounding frames. For example, the user device may receive an enhanced authentication response, indicating that the authentication response is followed by the plurality of sounding frames. In still further embodiments, the user device may receive the plurality of sounding frames augmented in an association response. In numerous additional embodiments, the user device may receive the plurality of sounding frames from the network device in advance of the association with the network device.

In still additional embodiments, the process 900 may determine channel state information (CSI) (block 930). In some more embodiments, the CSI may be determined based on the received plurality of sounding frames. In certain embodiments, the CSI may be determined in advance of or prior to the association between the user device and the network device.

In yet more embodiments, the process 900 may transmit the CSI (block 940). In still yet more embodiments, the CSI may be transmitted by the user device as a part of an association request. In yet more embodiments, the CSI can be transmitted in advance of the association. In many further embodiments, the CSI may be transmitted after receiving the association response augmented with the plurality of sounding frames from the network device and prior to the completion of the association process. In still yet more embodiments, the CSI may be transmitted concurrently with the completion of the association process, for example, immediately as the user devices associates with the network device.

In many additional embodiments, the process 900 may receive one or more beamformed transmissions (block 950). In still yet further embodiments, the user device may receive, from the network device, the one or more transmissions that are beamformed based on the CSI. In other words, transmitting the CSI to the network device in advance of the association between the user device and the network device, enables the user device to receive the one or more beamformed transmissions immediately as the association completes.

Although a specific embodiment for a user device initiated pre-association sounding procedure suitable for carrying out the various steps, processes, methods, and operations described herein is discussed with respect to FIG. 9, any of a variety of systems and/or processes may be utilized in accordance with embodiments of the disclosure. For example, the user device may receive one or more beamformed transmissions from the network device in advance of the association between the user device and the network device. The elements depicted in FIG. 9 may also be interchangeable with other elements of FIGS. 1-8 and 10 as required to realize a particularly desired embodiment.

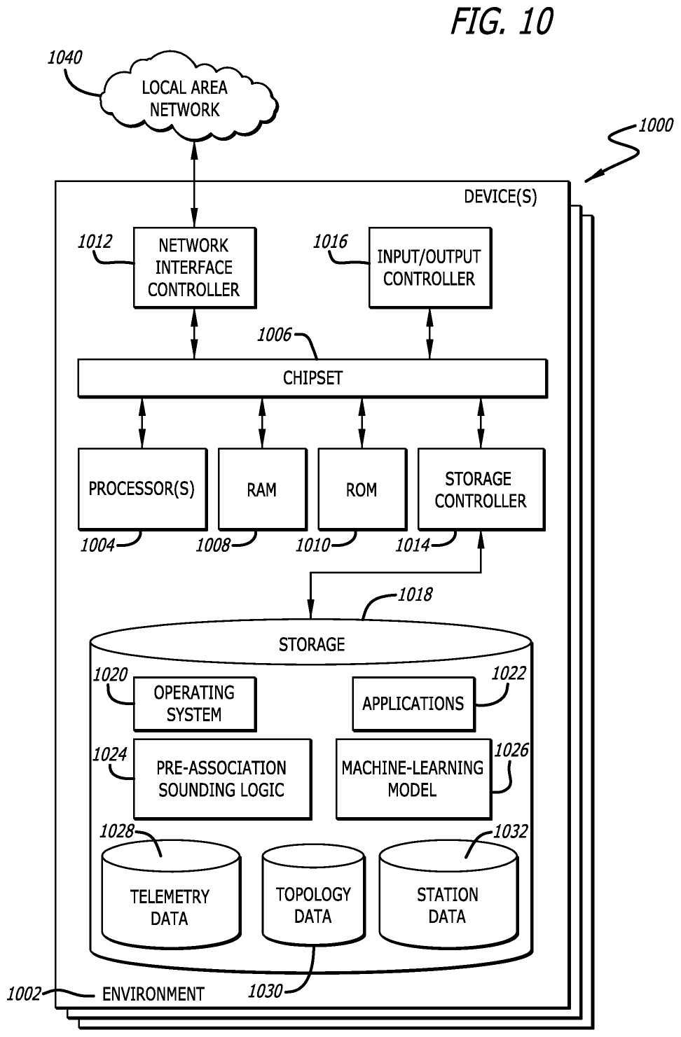

Referring to FIG. 10, a conceptual block diagram for one or more devices 1000 capable of executing components and logic for implementing the functionality and embodiments described above is shown. The embodiment of the conceptual block diagram depicted in FIG. 10 can illustrate a conventional server computer, workstation, desktop computer, laptop, tablet, network appliance, e-reader, smartphone, or other computing device, and can be utilized to execute any of the application and/or logic components presented herein. The device 1000 may, in some examples, correspond to physical devices or to virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In additional embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Different embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for example, store an operating system 1020, applications 1022, and data 1028, 1030, 1032, which are described in greater detail below. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

For example, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In various embodiment, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as application 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-9. In more embodiments, the device 1000 can also include computer-readable storage media having instructions stored thereupon for performing any of the other computer-implemented operations described herein.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10, and can include other components that are not explicitly shown in FIG. 10, or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

In many embodiments, the device 1000 can include a pre-association sounding logic 1024 that can be configured to perform one or more of the various steps, processes, operations, and/or other methods that are described above. Often, the pre-association sounding logic 1024 can be a set of instructions stored within a non-volatile memory that, when executed by the processor(s)/controller(s) 1004 can carry out these steps, etc. In some embodiments, the pre-association sounding logic 1024 may be a client application that resides on a network-connected device, such as, but not limited to, a server, switch, personal or mobile computing device, an access point (AP). In certain embodiments, the pre-association sounding logic 1024 can enable a sounding process between a user device and an AP to be completed in advance of association or concurrently with association between the user device and the AP.

In several embodiments, the pre-association sounding logic 1024 can enable the device 1000 (for example, an AP) to coordinate pre-association sounding between a user device and one or more target network devices. In numerous embodiments, the pre-association sounding logic 1024 can enable the device (for example, a user device) to initiate pre-association sounding with a target AP. In other words, the pre-association sounding logic 1024 can enable exchange of one or more sounding messages (e.g., an indication for a pre-association sounding capability, a plurality of sounding frames, and channel state information) between two devices (e.g., the user device and the AP) that are not associated yet or are in the process of association.

In a number of embodiments, the storage 1018 can include telemetry data 1028. In some embodiments, telemetry data 1028 can include information, for example, signal strength, location updates, movement patterns, and/or previous network hand-off events for the device 1000 and/or one or more other network devices. In many embodiments, the telemetry data 1028 may be utilized to predict a roaming event for the device 1000 or another moving device. In numerous embodiments, the telemetry data 1028 may be utilized to forecast a potential trajectory of a moving device or the device 1000.

In various embodiments, the storage 1018 can include topology data 1030. The topology data 1030 can comprise information detailing the physical or logical arrangement of network devices and their interconnections. This data can provide insights into the structure of the network, including the relationships between routers, switches, servers, and other components. Topology data 1030 can describe the actual layout of devices, such as their placement in a building or across multiple locations, while logical topology data may focus on the communication paths and relationships between devices regardless of their physical location. Understanding network topology is crucial for troubleshooting, optimizing performance, and planning for scalability. It can enable network administrators to identify potential points of failure, ensure efficient data flow, and make informed decisions about network expansion or reconfiguration. Advanced tools and technologies are often employed to visualize and analyze topology data 1030, aiding in the effective management and maintenance of complex network infrastructures. In further embodiments, topology data 1030 can enable identification of one or more target network devices that can serve a roaming user device (e.g., the device 1000).

In still more embodiments, the storage 1018 can include station data 1032. Station data 1032 may comprise detailed information about individual devices or stations connected to the network. This data includes unique identifiers known as MAC addresses assigned to each wireless device, indicating their presence on the network. Station data 1032 can encompass the current connection status of each device, indicating whether it is actively connected or not. Additionally, it can provide insights into signal strength, offering information about the quality of the wireless connection. Station data 1032 may also comprise data usage metrics which specify the amount of data transmitted and received by each device, aiding in network traffic analysis. Authentication status details may be available regarding whether a device has successfully undergone the authentication process to access the network, and IP addresses are assigned to facilitate communication within the network. In more embodiments, the station data 1032 can include monitoring data crucial for network administrators to optimize network performance, troubleshoot connectivity issues, and manage resources effectively, providing a comprehensive view of the devices interacting within the wireless environment. Advanced network management tools can offer real-time insights into station data, empowering administrators to make informed decisions regarding network optimization and security. In yet more embodiments, the station data 1032 can include pre-association sounding capability information of individual devices or stations connected to the network, sounding schedules of access points, and scanning schedules of user devices.

Finally, in many embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026. The ML model 1026 may be configured to learn roaming pattern of user devices and generate prediction as to when a user device would roam and what would be a potential trajectory of the moving user device. In some embodiments, a predictive roaming logic may be implemented by utilizing the ML model 1026.

The ML model(s) 1026 can be configured to generate inferences to make predictions or draw conclusions from data. An inference can be considered the output of a process of applying a model to new data. This can occur by learning from infrastructure data, sustainability data, and/or health data and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
at least one network interface controller configured to provide access to a network; and
a memory communicatively coupled to the processor, wherein the memory comprises a pre-association sounding logic that is configured to:
receive, from a network device, an indication associated with a pre-association sounding capability;
transmit a plurality of sounding frames to the network device;
receive channel state information from the network device based at least on the plurality of sounding frames; and
beamform at least one transmission to the network device based on the channel state information.

2. The device of claim 1, wherein the transmission of the plurality of sounding frames is conducted in advance of an association.

3. The device of claim 2, wherein the transmission of the plurality of sounding frames is to a user device.

4. The device of claim 3, wherein the association is between the device and the user device.

5. The device of claim 4, wherein the receiving of the channel state information is conducted in advance of the association.

6. The device of claim 1, wherein the indication associated with the pre-association sounding capability is received in one of a probe request, an authentication request, or an association request.

7. The device of claim 1, wherein the pre-association sounding logic is further configured to:
receive a probe request from the network device;
generate a probe response augmented with the plurality of sounding frames based on the probe request; and
transmit the probe response to the network device.

8. The device of claim 1, wherein the pre-association sounding logic is further configured to:
receive a probe request from the network device; and
transmit, to the network device, a probe response followed by the plurality of sounding frames based on the probe request.

9. The device of claim 1, wherein the pre-association sounding logic is further configured to:
receive an authentication request from the network device;
generate an authentication response augmented with the plurality of sounding frames based on the authentication request; and
transmit the authentication response to the network device.

10. The device of claim 1, wherein the pre-association sounding logic is further configured to:
receive an association request from the network device;
generate an association response augmented with the plurality of sounding frames based on the association request; and
transmit the association response to the network device.

11. The device of claim 1, wherein the pre-association sounding logic is further configured to:
predict a roaming event for the network device based on telemetry data; and
identify one or more target network devices for association with the network device based on the predicted roaming event.

12. The device of claim 11, wherein the pre-association sounding logic is further configured to transmit a sounding schedule of each of the one or more target network devices to the network device.

13. The device of claim 11, wherein the pre-association sounding logic is further configured to:
receive new channel state information for each of the one or more target network devices from the network device; and
transmit the new channel state information to each of the one or more target network devices.

14. A device, comprising:
a processor;
at least one network interface controller configured to provide access to a network; and
a memory communicatively coupled to the processor, wherein the memory comprises a pre-association sounding logic that is configured to:
transmit, to a network device, an indication associated with a pre-association sounding capability;
receive a plurality of sounding frames from the network device;
transmit channel state information to the network device based at least on the plurality of sounding frames; and
receive at least one beamformed transmission from the network device based on the channel state information.

15. The device of claim 14, wherein to transmit the channel state information, the pre-association sounding logic is configured to:
generate an association request augmented with the channel state information; and
transmit the association request to the network device.

16. The device of claim 14, wherein the pre-association sounding logic is further configured to receive a sounding schedule of one or more target network devices from the network device associated with the device.

17. The device of claim 16, wherein the pre-association sounding logic is further configured to scan one or more channels based on the sounding schedule.

18. The device of claim 17, wherein the pre-association sounding logic is further configured to:
receive a plurality of new sounding frames from the one or more target network devices on the one or more channels; and
determine new channel state information for each of the one or more target network devices based on the plurality of new sounding frames.

19. The device of claim 17, wherein the device is a Multi-link Device that comprises a plurality of transceivers, and is configured to communicate with the network device via one of the plurality of transceivers and concurrently scan the one or more channels via another transceiver of the plurality of transceivers.

20. A method for performing sounding, comprising:
receiving, from a network device, an indication associated with a pre-association sounding capability;
transmitting a plurality of sounding frames to the network device;
receiving channel state information from the network device based at least on the plurality of sounding frames; and
beamforming at least one transmission to the network device based on the channel state information.
